(19) United States
(12) Patent Application Publication
(10) Pub. No.: US 2026/0035526 A1
(43) Pub. Date: Feb. 5, 2026

(54) AEROGEL ARTICLES MADE FROM AEROGEL PARTICLES AND METHODS FOR MAKING THE SAME

(71) Applicant: Blueshift Materials, Inc., Spencer, MA (US)

(72) Inventors: David IRVIN, Spencer, MA (US); Shima DAYARIAN, Spencer, MA (US); Lawino KAGUMBA, Spencer, MA (US); Garrett POE, Spencer, MA (US); Liu YANG, Spencer, MA (US)

(73) Assignee: Blueshift Materials, Inc., Spencer, MA (US)

(21) Appl. No.: 19/354,490

(22) Filed: Oct. 9, 2025

Related U.S. Application Data
(62) Division of application No. 18/002,319, now abandoned.
(60) Provisional application No. 63/041,805, filed on Jun. 19, 2020.

(51) Int. Cl. C08J 9/236; C08J 9/42; C08L 79/08

(52) U.S. Cl. CPC C08J 9/236; C08J 9/42; C08L 79/08; C08J 2205/026; C08J 2379/08; C08J 2463/00

(57) ABSTRACT

An aerogel article that includes a plurality of aerogel particles is disclosed. The plurality of aerogel particles each include a polymeric matrix defining pores of the plurality of aerogel particles. The polymeric matrix includes a non-consolidated portion comprising the pores and a consolidated portion plasticized by a plasticizing solvent. The plurality of aerogel particles are bonded to each other through an interface that comprises the consolidated portions of adjacent ones of the plurality of aerogel particles.

### CROSS-REFERENCE TO RELATED APPLICATIONS

This application is a divisional of U.S. patent application Ser. No. 18/002,319 filed Dec. 19, 2022, which is a national phase application under 35 USC § 371 of International App. PCT/US2021/037856 filed Jun. 17, 2021, which claims the benefit of priority to U.S. Prov. App. 63/041,805 filed Jun. 19, 2020. The contents of each application are incorporated herein by reference.

### BACKGROUND OF THE INVENTION

### A. Field of the Invention

The present invention relates generally, but not by way of limitation, to relatively large polymeric aerogel articles, such as, for example, aerogel stock shapes, aerogel blocks, aerogel monoliths, and/or aerogel structures.

### B. Description of Related Art

Aerogels typically exhibit remarkably low thermal insulation values as well as low dielectric constant and loss tangent values, which makes them well-suited to a variety of uses in a variety of industries, including the consumer electronics, aerospace, and defense industries. The manufacture of an aerogel, however, involves the use of a solvent that must subsequently be removed from the aerogel's pores. This is often accomplished by drying the aerogel, usually after that solvent has been substituted for a more-volatile one. And these steps can take a significant amount of time to complete, which increases with the aerogel's size. To illustrate, for a one-inch-thick aerogel block, the solvent-substitution step can take from 1 to 12 days, and the drying step can take from 1 to 10 days. This limits the size of aerogels that can be manufactured, at least in a commercially-reasonable manner.

### SUMMARY OF THE INVENTION

In some of the present methods, these shortcomings can be addressed by consolidating aerogel particles to produce an aerogel article. In this way, the solvent-substitution and drying steps need not be performed on the aerogel article itself; instead, they can be performed more quickly on smaller-scale aerogel particles from which the structures are produced.

Further, a consolidation-promoting binder can be used; however, in large amounts, the binder might render the aerogel article undesirably less insulative, heavier, or otherwise different from the original properties of the aerogel particles. When consolidating the particles, however, a balance should be struck between ensuring adequate consolidation of the particles and preserving properties of the original aerogel particles. For example, while high temperature and/or high pressure might promote consolidation, such conditions might also melt and/or crush the particles, hindering at least their aerogel's insulative properties.

In the present methods, such a balance can be achieved in one or more of various ways. In some methods, for instance, the particles can be combined with a plasticizing solvent (e.g., an amount that is from 0.01% to 10% or from 0.5% to 5% of the weight of the particles and the plasticizing solvent), which can promote bonding of the particles, in some instances, via the polymeric material of the particles' aerogel. In this way, when consolidating the particles, lower temperatures and/or pressures can be used, the need for a binder can be reduced or eliminated, and/or the like.

Additionally or alternatively, in some methods, the particles can be treated with a binder in an amount (e.g., that is from 1% to 10%, from 3% to 7%, from 4% to 6%, or approximately 5% of the weight of the particles and the binder) that promotes effective consolidation without undesirably hindering—and in some instances, improving—the particles' aerogel's properties. For instance, such methods can be used to produce particle-based aerogel articles having thermal properties that are comparable to traditional, non-particle-based aerogel articles (e.g., a 10% decomposition temperature that is from 350° C. to 650° C., preferably from 400° C. to 600° C., more preferably from 450° C. to 570° C., even more preferably from 500° C. to 550° C., or most preferably from 520° C. to 540° C. or about 530° C.). Some such particle-based aerogel articles can, at the same time, have comparable (or even improved) structural characteristics (e.g., a modulus of elasticity that is from 13.6 to 38.64 MPa and/or an ultimate compressive strength that is at least 1 MPa or at least 2 MPa or 1 MPa to 10 MPa or 1 MPa to 5 MPa). As with the plasticizing solvent described above, utilizing such a binder can permit the use of lower temperatures and/or pressures when consolidating the particles.

Additionally or alternatively, in some instances during the aerogel particle manufacturing process, the resulting aerogel particles may include a plasticizing solvent. By way of example, aerogels can be made by using a process that includes 1) preparation of the polymer gel, 2) optional solvent exchange, and 3) drying of the polymeric solution to form the aerogel. These process steps are described in detail in US 2020/0199323, the disclosure of which is incorporated into the present application by reference. During preparation of the polymer aerogel, certain catalysts can be used to form the polymer (e.g., 2-Methylimidazole (2 MI) or pyridine and butyric anhydride (BA) can be used for polyimide gels). If a catalyst has plasticization properties (e.g., pyridine), and if the solvent exchange step 2) is only partially performed, then the resulting catalyst (e.g., pyridine) may be present during the drying step 3) and in the resulting aerogel. Alternatively, a plasticizing solvent could be added to the step 2) optional solvent exchange step or to the step 3) drying step such that the resulting aerogel includes a plasticizing solvent. Still further, the drying step 3) may not be fully performed such that at least a portion of the plasticization solvent remains. The resulting aerogel can then be subjected to a crushing, grinding, or milling step to form particles that include a plasticization solvent.

In some methods, via such a plasticizing solvent and/or binder, the particles may be exposed to: (1) a temperature during consolidation that does not exceed the glass transition temperature or the melting temperature of the polymeric material of the particles' aerogel and/or 350° C. or 300° C.; and/or (2) a pressure during consolidation that does not exceed 5, 10, 25, 50, 75, 100, 125, 150, 175, 200, 225, or 250 psi. In either or both of these ways, melting and/or crushing of the particles can be mitigated.

Some of the present methods for making an aerogel article comprise: disposing a composition into a mold, the composition comprising aerogel particles, each having a polymeric matrix defining pores of the aerogel particle, and a plasticizing solvent that is from 0.01% to 10% of the weight of the aerogel particles and the plasticizing solvent, and forming the aerogel article at least by applying pressure to the composition disposed within the mold such that the polymeric matrix of adjacent ones of the aerogel particles bonds the adjacent aerogel particles to one another. In some methods, the aerogel particles contain at least a portion of the plasticizing solvent before the composition is disposed into the mold. In some methods, the plasticizing solvent is from 0.5% to 5%, optionally from 2% to 5%, of the weight of the aerogel particles and the plasticizing solvent.

In some methods, the plasticizing solvent comprises a polar aprotic solvent, and, optionally, the polar aprotic solvent comprises dimethyl sulfoxide (DMSO), dimethyl acetamide (DMAc), dimethyl formamide (DMF), hexamethylphosphoramide (HMPA), propylene carbonate (PC) and/or N-methyl-2-pyrrolidone (NMP). In some methods, the plasticizing solvent comprises DMSO. In some methods, the plasticizing solvent comprises a polar protic solvent, and, optionally, the polar protic solvent comprises cresol, phenol, t-butyl alcohol, and/or an alcohol-containing terpene. In some methods, the plasticizing solvent can include amide solvents such as but not limited to formamide, N-methylformamide, N,N-dimethylformamide, N,N-diethylformamide, N,N-dimethylacetamide, N,N-diethylacetamide, 2-pyrrolidone, N-methyl-2-pyrrolidone, 1-methyl-2-pyrrolidinone, N-cyclohexyl-2-pyrrolidone, N-vinylacctamide, N-vinylpyrrolidone, hexamethylphosphoramide, and 1,13-dimethyl-2-imidazolidinone; organosulfur solvents such as but not limited to dimethylsulfoxide, diethylsulfoxide, methylsulfonylmethane, and sulfolane; ether solvents including but not limited to cyclopentyl methyl ether, di-tert-butyl ether, diethyl ether, diethylene glycol diethyl ether, diglyme, diisopropyl ether, dimethoxyethane, dimethoxymethane, 1,4-dioxane, ethyl tert-butyl ether, glycol ethers, methoxyethane, 2-(2-methoxyethoxy)ethanol, methyl tert-butyl ether, 2-methyltetrahydrofuran, morpholine, tetraglyme, tetrahydrofuran, tetrahydropyran, and triglyme; hydrocarbon solvents including but not limited to benzene, cycloheptane, cyclohexane, cyclohexene, cyclooctane, cyclopentane, decalin, dodecane, durene, heptane, hexane, limonene, mesitylene, methylcyclohexane, naphtha, octadecene, pentamethylbenzene, pentane, pentanes, petroleum benzene, petroleum ether, toluene tridecane, turpentine, and xylene; nitro solvents including but not limited to nitrobenzene, nitroethane, and nitromethane; alcohol solvents including but not limited to methanol, ethanol, 1-propanol, 2-propanol, 1-butanol, 2-butanol, isobutanol, tert-butanol, 3-methyl-2-butanol, 3,3-dimethyl-2-butanol, 2-pentanol, 3-pentanol, 2,2-dimethylpropan-1-ol, cyclohexanol, diethylene glycol, tert-amyl alcohol, phenols, cresols, xylenols, catechol, benzyl alcohol, 1,4-butanediol, 1,2,4-butanetriol, butanol, 2-butanol, N-butanol, tert-butyl alcohol, diethylene glycol, ethylene glycol, 2-ethylhexanol, furfuryl alcohol, glycerol, 2-(2-methoxyethoxy)ethanol, 2-methyl-1-butanol, 2-methyl-1-pentanol, 3-methyl-2-butanol, neopentyl alcohol, 2-pentanol, 1,3-propanediol, and propylene glycolcycol; ketone solvents including but not limited to hexanone, acetone, methyl ethyl ketone, methyl isobutyl ketone, disobutyl ketone, acetophenone, butanone, cyclopentanone, ethyl isopropyl ketone, 2-hexanone, isophorone, mesityl oxide, methyl isopropyl ketone, 3-methyl-2-pentanone, 2-pentanone, and 3-pentanoneacetyl acetone; halogenated solvents including but not limited to benzotrichloride, bromoform, bromomethane, carbon tetrachloride, chlorobenzene, 1,2-dichlorobenzene, 1,3-dichlorobenzene, 1,4-dichlorobenzene, chlorofluorocarbon, chloroform, chloromethane, 1,1-dichloro-1-fluoroethane, 1,1-dichloroethane, 1,2-dichloroethane, 1,1-dichloroethene, 1,2-dichloroethene, dichloromethane, diiodomethane, FC-75, haloalkane, halomethane, hexachlorobutadiene, hexafluoro-2-propanol, parachlorobenzotrifluoride, perfluoro-1,3-dimethylcyclohexane, perfluorocyclohexane, perfluorodecalin, perfluorohexane, perfluoromethylcyclohexane, perfluoromethyldecalin, perfluorooctane, perfluorotoluene, perfluorotripentylamine, tetrabromomethane, 1,1,1,2-tetrachloroethane, 1,1,2,2-tetrachloroethane, tetrachloroethylene, 1,1,1-tribromoethane, 1,3,5-trichlorobenzene, 1,1,1-trichloroethane, 1,1,2-trichloroethane, trichloroethylene, 1,2,3-trichloropropane, 2,2,2-trifluoroethanol, and trihalomethane; ester solvents including but not limited to methyl acetate, ethyl acetate, butyl acetate, 2-methoxyethyl acetate, benzyl benzoate, bis(2-ethylhexyl) adipate, bis(2-ethylhexyl) phthalate, 2-butoxyethanol acetate, sec-butyl acetate, tert-butyl acetate, diethyl carbonate, dioctyl terephthalate, ethyl acetate, ethyl acetoacetate, ethyl butyrate, ethyl lactate, ethylene carbonate, hexyl acetate, isoamyl acetate, isobutyl acetate, isopropyl acetate, methyl acetate, methyl lactate, methyl phenylacetate, methyl propionate, propyl acetate, propylene carbonate, and triacetin; water, or mixtures thereof. In some methods, the plasticizing solvent comprises a ketone-based solvent and/or a ketone-containing terpenoid. In some methods, the plasticizing solvent comprises an aldehyde and/or an aldehyde-containing terpenal. In some methods, the plasticizing solvent comprises a terpene. In some methods, the plasticizing solvent comprises an ester based solvent. In some methods, the plasticizing solvent comprises an amide based solvent.

Some of the present methods for making an aerogel article comprise disposing a composition into a mold, the composition comprising aerogel particles, each having a polymeric matrix defining pores of the aerogel particle, and a binder that is from 1% to 10% of the weight of the aerogel particles and the binder, and forming the aerogel article at least by applying pressure to the composition disposed within the mold such that the binder bonds adjacent ones of the aerogel particles to one another. In some methods, the aerogel article has an ultimate compressive strength of at least 1 MPa, optionally, at least 2 MPa.

In some methods, the binder comprises an epoxy, thermoplastic based adhesive, polyimides, polyimide precursors such as polyisoimide, polyamic acid salts, polyamic esters, polysilyl esters, polyamic acid, or any combinations thereof. In some methods, the binder comprises an epoxy. In some methods, the binder is from 3% to 7%, optionally, between 4% and 6%, optionally, approximately 5%, of the weight of the aerogel particles and the binder.

In some methods, applying pressure is performed such that the aerogel particles are not exposed to a pressure that exceeds 10 psi.

Some methods comprise forming the aerogel article at least by applying heat to the composition disposed within the mold. In some methods, applying heat is performed such that, for each of at least a majority of, optionally, for each of substantially all of, the aerogel particles, the aerogel particle is not exposed to a temperature that exceeds the glass transition temperature or the melting temperature of the polymeric matrix. In some methods, applying heat is performed such that the aerogel particles are not exposed to a temperature that exceeds 300° C.

In some methods, the polymeric matrix of at least one of, optionally substantially all of, the particles comprises an organic polymer or a hybrid organic/inorganic polymer. In some methods, the polymeric matrix of at least one of, optionally substantially all of, the particles comprise polyimide, polyamide, polyaramid, polyurethane, polyurea, polyester, polycarbonate, polysiloxane, polyacrylic, or a blend thereof. In some methods, the polymeric matrix of at least one of, optionally substantially all of, the particles comprises polyimide.

In some methods, the aerogel article has a density that is less than 0.75 g/cm³, optionally, the aerogel article has a density that is from approximately 0.2 g/cm³ to approximately 0.5 g/cm³. In some methods, the aerogel article has a relatively large thicknesses (e.g., greater than 1.0, 2.0, 3.0, 3.5, 4.0, 4.5, 5.0, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, or 25 cm, or more, or any range therein). In some aspects, the aerogel article can have a thickness greater than 25 cm (e.g., 30, 40, 50, 60, 70, 80, 90, or 100 cm or more, or any range therein). In some particular aspects, the thickness of the article can range from greater than 1 cm to 25 cm. In some aspects, the thickness of the article can range from 1 cm to 20 cm. In some aspects, the thickness of the article can range from 1 cm to 15 cm. In some aspects, the thickness of the article can range from 1 cm to 10 cm. In some aspects, the thickness of the article can range from 1 cm to 5 cm. In other aspects, the aerogel article can have a relatively thin thickness such as 0.1, 0.2, 0.3, 0.4, 0.5, 0.6, 0.7, 0.8, 0.9, or 1 cm or less or any range therein. In some aspects, the thickness of the article can range from 0.1 cm to 1 cm. In some aspects, the thickness of the article can range from 0.1 cm to 0.5 cm. In some aspects, the thickness of the article can range from 0.1 cm to 0.25 cm. In some instances, the aerogel articles can be, for example, aerogel stock shapes, aerogel blocks, aerogel monoliths, and/or aerogel films. The thickness of the aerogel articles can be modified as desired. For example, a thickness of a mold used during casting can determine the thickness of a resulting article. By way of another example, the amount used of a composition having aerogel particles can determine the thickness of a resulting article (e.g., amount placed on a substrate can determine the thickness of a film). In some methods, the aerogel particles form at least a majority of the outer surface of the aerogel article.

Some of the present aerogel articles comprise aerogel particles, each comprising a polymeric matrix defining pores of the aerogel particle, and a binder that is from 1% to 10% of the weight of the aerogel particles and the binder. In some aerogel articles, the binder comprises an epoxy. In some aerogel articles, the binder is from 3% to 7%, optionally, from 4% to 6%, optionally, approximately 5%, of the weight of the aerogel particles and the binder.

In some aerogel articles, the polymeric matrix of at least one of, optionally substantially all of, the particles comprises an organic polymer. In some aerogel articles, the polymeric matrix of at least one of, optionally substantially all of, the particles comprises polyimide, polyamide, polyaramid, polyurethane, polyurea, polyester, polycarbonate, polysiloxane, polyacrylic, or a blend thereof. In some aerogel articles, the polymeric matrix of at least one of, optionally substantially all of, the particles comprises polyimide.

Some aerogel articles have an ultimate compressive strength of at least 1 MPa, optionally, at least 2 MPa. Some aerogel articles have a density that is less than 0.75 g/cm³, optionally, a density that is from approximately 0.2 g/cm³ to approximately 0.5 g/cm³.

In certain aspects of the present invention, the resulting article after the particle consolidation process can be considered a porous material. The porous material can be an open celled porous material. In certain other aspects, the porous material can be a closed celled porous material. In certain preferred aspects, the porous material can comprise a network of consolidated aerogel particles. In certain aspects, the porous material can include 50%, 40%, 30%, 20%, 10%, or 5%, or less, by weight, of consolidated aerogel particles. In other aspects, the porous material can include greater than 50%, 60%, 70%, 80%, 95%, or more, by weight, of consolidated aerogel particles. In some aspects, the porous material can include up to 100% by weight of consolidated aerogel particles. In certain aspects, the porous material can include a combination of consolidated aerogel particles and a foam (e.g., organic or silicone foams). Non-limiting examples of foam can include polyurethane, polystyrene, polyvinyl chloride, (meth)acrylic polymer, polyamide, polyimide, polyaramide, polyuria, polyester, polyolefin (such as polyethylene, polypropylene, ethylene propylene diene monomer (EPDM) foam, or the like), polyethylene terephthalate, polybutylene terephthalate, polyvinyl chloride, polyvinyl acetate, ethyl vinyl alcohol (EVOH), ethylene-vinyl acetate (EVA), polymethyl methacrylates, polyacrylates, polycarbonates, polysulphonates, or synthetic rubber foam, or any combinations thereof.

Also disclosed in the context of the present invention are aspects 1-32. Aspect 1 is a method for making an aerogel article, the method comprising: disposing a composition into a mold, the composition comprising: aerogel particles, each having a polymeric matrix defining pores of the aerogel particle; and a plasticizing solvent that is from 0.01% to 10% of the weight of the aerogel particles and the plasticizing solvent; and forming the aerogel article at least by applying pressure to the composition disposed within the mold such that the polymeric matrix of adjacent ones of the aerogel particles bonds the adjacent aerogel particles to one another. Aspect 2 is the method of aspect 1, wherein the aerogel particles contain at least a portion of the plasticizing solvent before the composition is disposed into the mold. Aspect 3 is the method of aspect 1 or 2, wherein: the plasticizing solvent comprises a polar aprotic solvent; and optionally, the polar aprotic solvent comprises DMSO, DMAc, DMF, HMPA, and/or NMP. Aspect 4 is the method of aspect 3, wherein the plasticizing solvent comprises DMSO. Aspect 5 is the method of aspect 1 or 2, wherein: the plasticizing solvent comprises a polar protic solvent; and optionally, the polar protic solvent comprises cresol, phenol, t-butyl alcohol, and/or an alcohol-containing terpene. Aspect 6 is the method of aspect 1 or 2, wherein the plasticizing solvent comprises a ketone-based solvent and/or a ketone-containing terpenoid. Aspect 7 is the method of aspect 1 or 2, wherein the plasticizing solvent comprises an aldehyde and/or an aldehyde-containing terpenal. Aspect 8 is the method of aspect 1 or 2, wherein the plasticizing solvent comprises a terpene. Aspect 9 is the method of any of aspects 1-8, wherein the plasticizing solvent is from 0.5% to 5%, optionally from 2% to 5%, of the weight of the aerogel particles and the plasticizing solvent. Aspect 10 is a method for making an aerogel article, the method comprising: disposing a composition into a mold, the composition comprising: aerogel particles, each having a polymeric matrix defining pores of the aerogel particle; and a binder that is from 1% to 10% of the weight of the aerogel particles and the binder; and forming the aerogel article at least by applying pressure to the composition disposed within the mold such that the binder bonds adjacent ones of the aerogel particles to one another. Aspect 11 is the method of aspect 10, wherein the binder comprises an epoxy. Aspect 12 is the method of aspect 10 or 11, wherein the binder is from 3% to 7%, optionally, from 4% to 6%, optionally, approximately 5%, of the weight of the aerogel particles and the binder. Aspect 13 is the method of any of aspects 10-12, wherein the aerogel article has an ultimate compressive strength of at least 1 MPa, optionally, at least 2 MPa. Aspect 14 is the method of any of aspects 1-13, wherein applying pressure is performed such that the aerogel particles are not exposed to a pressure that exceeds 10 psi. Aspect 15 is the method of any of aspects 1-14, comprising forming the aerogel article at least by applying heat to the composition disposed within the mold. Aspect 16 is the method of aspect 15, wherein applying heat is performed such that, for each of at least a majority of, optionally, for each of substantially all of, the aerogel particles, the aerogel particle is not exposed to a temperature that exceeds the glass transition temperature or the melting temperature of the polymeric matrix. Aspect 17 is the method of aspect 15 or 16, wherein applying heat is performed such that the aerogel particles are not exposed to a temperature that exceeds 300° C. Aspect 18 is the method of any of aspects 1-17, wherein the polymeric matrix of at least one of, optionally substantially all of, the particles comprises an organic polymer. Aspect 19 is the method of aspect 18, wherein the polymeric matrix of at least one of, optionally substantially all of, the particles comprises polyimide, polyamide, polyaramid, polyurethane, polyurea, polyester, or a blend thereof. Aspect 20 is the method of aspect 19, wherein the polymeric matrix of at least one of, optionally substantially all of, the particles comprises polyimide. Aspect 21 is the method of any of aspects 1-20, wherein the aerogel article has a density that is less than 0.75 g/cm³, optionally, the aerogel article has a density that is from approximately 0.2 g/cm³ to approximately 0.5 g/cm³. Aspect 22 is the method of any of aspects 1-21, wherein the aerogel article has a thickness of at least 1 cm. Aspect 23 is the method of any of aspects 1-22, wherein the aerogel particles form at least a majority of the outer surface of the aerogel article.

Aspect 24 is an aerogel article comprising: aerogel particles, each comprising a polymeric matrix defining pores of the aerogel particle; and a binder that is from 1% to 10% of the weight of the aerogel particles and the binder. Aspect 25 is the aerogel article of aspect 24, wherein the binder comprises an epoxy. Aspect 26 is the aerogel article of aspect 24 or 25, wherein the binder is from 3% to 7%, optionally, from 4% to 6%, optionally, approximately 5%, of the weight of the aerogel particles and the binder. Aspect 27 is the aerogel article of any of aspects 24-26, wherein the aerogel article has an ultimate compressive strength of at least 1 MPa, optionally, at least 2 MPa. Aspect 28 is the aerogel article of any of aspects 24-27, wherein the polymeric matrix of at least one of, optionally substantially all of, the particles comprises an organic polymer. Aspect 29 is the aerogel article of aspect 28, wherein the polymeric matrix of at least one of, optionally substantially all of, the particles comprises polyimide, polyamide, polyaramid, polyurethane, polyurea, polyester, or a blend thereof. Aspect 30 is the aerogel article of aspect 29, wherein the polymeric matrix of at least one of, optionally substantially all of, the particles comprises polyimide. Aspect 31 is the aerogel article of any of aspects 24-30, wherein the aerogel article has a density that is less than 0.75 g/cm³, optionally, the aerogel article has a density that is from approximately 0.2 g/cm³ to approximately 0.5 g/cm³. Aspect 31 is the aerogel article of any of aspects 24-30, wherein the aerogel article has a thickness of at least 1 cm. Aspect 32 is the aerogel article of any of aspects 24-31, wherein the aerogel particles form at least a majority of the outer surface of the aerogel article.

In still another aspect of the present invention there is disclosed an aerogel article comprising aerogel particles, each comprising a polymeric matrix defining pores of the aerogel particle, and a binder. The aerogel particles can be consolidated. The aerogel article can have any one of, any combination of, or all of the following properties: (a) a porosity of 70% to 90%; (b) a bulk density of 0.30 g/cm³ to 0.45 g/cm³; (c) a surface area of 7.75 m²/g to 15.0 m²/g; (d) a pore volume of 0.02 cm³/g to 0.06 cm³/g; (e) a modulus of elasticity of 35 MPa to 95 MPa; (f) a TGA 10% weight loss temperature of 315° C. to 525° C.; and/or (g) a thermal conductivity of 47 mW/m K to 60 mW/m K. In certain aspects, the aerogel article includes the features of at least (a), (b), (c), (f), and (g). In certain aspects, the aerogel article has a porosity of 70% to 85%. In certain aspects, the aerogel article has a bulk density of 0.30 g/cm³ to 0.40 g/cm³. In certain aspects, the aerogel article has a surface area of 9.0 m²/g to 15.0 m²/g. In certain aspects, the aerogel article has a pore volume of 0.035 cm³/g to 0.055 cm³/g. In certain aspects, the aerogel article has a modulus of elasticity of 35 MPa to 95 MPa or 55 MPa to 95 MPa or 75 MPa to 95 MPa. In certain aspects, the aerogel article has a TGA 10% weight loss temperature of 315° C. to 525° C. or 315° C. to 400° C. or 490° C. to 525° C. In certain aspects, the aerogel article has a thermal conductivity of 47 mW/m K to 60 mW/m K. The aerogel article can include 2 wt. % to 20 wt. % of the binder, based on the total weight of the aerogel particles and the binder. In certain aspects, the aerogel article can include 3 wt. % to 7 wt. % of the binder. In certain aspects, the aerogel article can include 4 wt. % to 6 wt. % of the binder. In certain aspects, the aerogel article can include approximately 5 wt. % of the binder. In certain aspects, the binder is epoxy. Still further, the contents of Table 2 in the Examples is incorporated into this paragraph by reference.

In still another aspect of the present invention there is disclosed an aerogel article comprising aerogel particles, each comprising a polymeric matrix defining pores of the aerogel particle, and a plasticizing solvent. The aerogel particles can be consolidated. The aerogel article can have any one of, any combination of, or all of the following properties: (a) a porosity of 80% to 90%; (b) a bulk density of 0.20 g/cm³ to 0.30 g/cm³; (c) a surface area of 7.75 m²/g to 9.0 m²/g; (d) a pore volume of 0.010 cm³/g to 0.025 cm³/g; (c) a modulus of elasticity of 6 MPa to 35 MPa; (f) a TGA 10% weight loss temperature of 530° C. to 545° C.; and/or (g) a thermal conductivity of 47 mW/m K to 55 mW/m K. In certain aspects, the aerogel article includes the features of at least (a), (c), (f), and (g). In certain aspects, the aerogel article has a porosity of 80% to 90%. In certain aspects, the aerogel article as a bulk density of 0.20 g/cm³ to 0.26 g/cm³. In certain aspects, the aerogel article has a surface area of 7.75 m²/g to 9.0 m²/g. In certain aspects, the aerogel article has a pore volume of 0.017 cm³/g to 0.025 cm³/g. In certain aspects, the aerogel article has a modulus of elasticity of 17 MPa to 35 MPa. In certain aspects, the aerogel article has a TGA 10% weight loss temperature of 530° C. to 540° C. In certain aspects, the aerogel article has a thermal conductivity of 47 mW/m K to 55 mW/m K. In certain aspects, the aerogel article comprises 2 wt. % to 30 wt. % of the plasticizing solvent, based on the total weight of the aerogel particles and the plasticizing solvent. In certain aspects, the plasticizing solvent is DMSO. Still further, the contents of Table 1 in the Examples is incorporated into this paragraph by reference.

The terms “binder” or “binding agent” refers to a compound or material that is capable of holding or binding two or more materials/compositions/components/ingredients (e.g., aerogel particles) together. The holding or binding can be through adhesive and/or cohesive bonds and/or forces.

The term “aerogel” refers to a class of materials that are generally produced by forming a gel, removing a mobile interstitial solvent phase from the pores, and then replacing it with a gas or gas-like material. By controlling the gel and evaporation system, density, shrinkage, and pore collapse can be minimized. Aerogels usable in the present invention can include macropores, mesopores, and/or micropores. In preferred aspects, the majority (e.g., more than 50%) of the aerogel's pore volume can be made up of macropores. In other alternative aspects, the majority of the aerogel's pore volume can be made up of mesopores and/or micropores such that less than 50% of the aerogel's pore volume is made up of macropores. In some embodiments, aerogels usable in the present invention can have low bulk densities (about 0.75 g/cm³ or less, preferably about 0.01 g/cm³ to about 0.5 g/cm³), high surface areas (generally from about m²/g 10 to 1,000 m²/g and higher, preferably about 50 m²/g to about 1000 m²/g), high porosities (about 20% and greater, preferably greater than about 85%), and/or relatively large pore volumes (more than about 0.3 mL/g, preferably about 1.2 mL/g and higher).

The term “coupled” is defined as connected, although not necessarily directly, and not necessarily mechanically. Two items that are “coupled” may be unitary with each other or may be connected to one another via one or more intermediate components or elements.

The terms “a” and “an” are defined as one or more unless this disclosure explicitly requires otherwise.

The term “substantially” is defined as largely, but not necessarily wholly, what is specified (and includes what is specified; e.g., substantially 90 degrees includes 90 degrees, and substantially parallel includes parallel), as understood by a person of ordinary skill in the art. In any disclosed embodiment, the terms “substantially,” “approximately,” and “about” may be substituted with “within [a percentage] of” what is specified, where the percentage is 0.1, 1, 5, or 10%.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and containing”) are open-ended linking verbs. As a result, an apparatus that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Any embodiment of any of the apparatuses and methods can consist of or consist essentially of—rather than comprise/have/include/contain—any of the described elements, features, and/or steps. Thus, in any of the claims, the phrase “consisting of” or “consisting essentially of” can be substituted for any of the open-ended linking verbs recited above in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate identical structures. Rather, the same reference numbers may be used to indicate similar features or features with similar functionalities, as may non-identical reference numbers.

FIGS. 1A-1C illustrate steps of some of the present methods, including disposing a composition comprising aerogel particles and a plasticizing solvent and/or a binder into a mold and forming an aerogel article at least by applying pressure to the composition in the mold.

FIG. 2A illustrates one of the present aerogel articles in which adjacent ones of the aerogel particles are bonded to one another via their polymeric matrices.

FIG. 2B illustrates one of the present aerogel articles in which adjacent ones of the aerogel particles are bonded to one another via a binder.

FIG. 3 includes images of molds used to produce some of the present aerogel articles and shows a 1 in ×1 in ×1 in aluminum mold in an open position (a) and in a closed position (b), a 8 in×3 in ×1 in aluminum mold (c), a 3 in ×3 in ×1 in aluminum mold (d), and PTFE molds (e and f).

FIGS. 4A and 4B show thermogravimetric analyses of one of the present aerogel articles made using DMSO (FIG. 4A) and one of the present aerogel articles made using epoxy (FIG. 4B).

FIGS. 5A and 5B show nitrogen adsorption-desorption isotherms at 77 K for one of the present aerogel articles made using DMSO (FIG. 5A) and one of the present aerogel articles made using epoxy (FIG. 5B).

FIGS. 6A and 6B show stress-strain curves (using a 0.65 mm/min head speed) for one of the present aerogel articles made using DMSO (FIG. 6A) and one of the present aerogel articles made using epoxy (FIG. 6B).

FIG. 7 includes SEM images for one of the present aerogel articles comprising 1 wt. % (a), 3 wt. % (b), 5 wt. % (c), and 7 wt. % (d) of epoxy.

FIG. 8 shows the pore size distributions obtained using BJH method on nitrogen desorption data on the aerogel articles made using DMSO as plasticizer (FIG. 8A) and using epoxy (FIG. 8B).

FIG. 9 shows the pore size distributions obtained using mercury intrusion porosimetry on the aerogel articles made using DMSO as plasticizer (FIG. 9A) and using epoxy (FIG. 9B).

### DETAILED DESCRIPTION

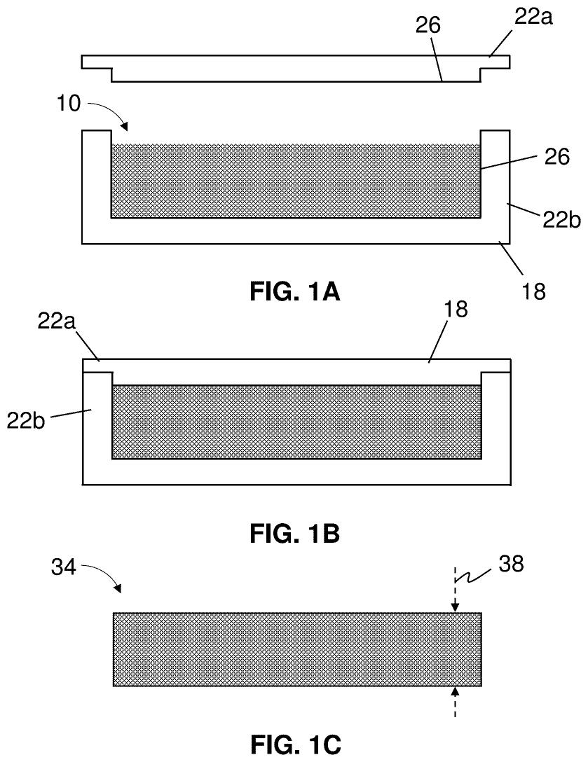

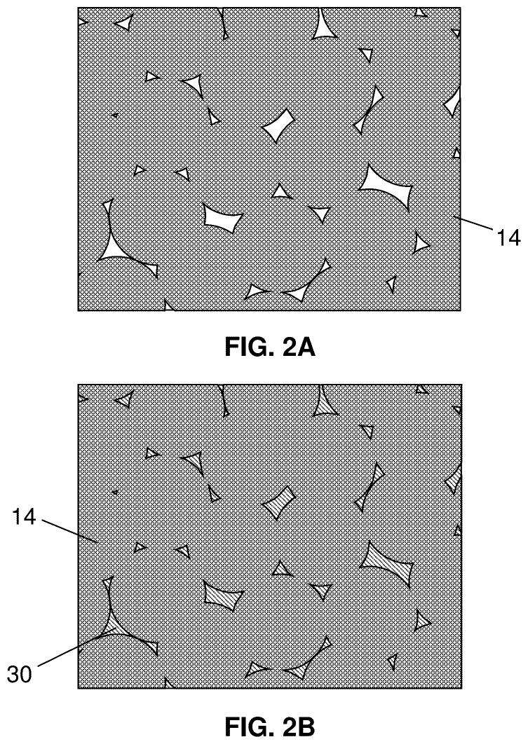

Referring to FIGS. 1A-IC, shown are steps of some of the present methods. Starting with FIG. 1A, some methods include a step of disposing a composition (e.g., 10) comprising aerogel particles (e.g., 14, labeled in FIGS. 2A and 2B) into a mold (e.g., 18). Illustrative mold 18 can comprise first and second mold portions, 22a and 22b, each defining a molding surface 26. And mold portions 22a and 22b can be movable relative to one another between an open position (FIG. 1A) and a closed position (FIG. 1B) in which molding surfaces 26 cooperate to define a mold cavity. Mold portions 22a and 22b can be made of, for example, aluminum, PTFE (e.g., including as an anti-stick coating), and/or the like. One or more measures can be taken to facilitate packing of the composition within the mold, such as, for example, vibrating the mold. Although not shown, the mold 18 can be in the form of any desired shape for the resulting article. Therefore, the resulting article can have any desired shape based on the shape of the mold 18.

The aerogel particles can each have a polymeric matrix that defines pores of the aerogel particle. And each of at least a majority of—up to and including all of—the aerogel particles can comprise the same polymeric matrix. To be clear, however, aerogel particles (e.g., 14) including different polymeric matrices are encompassed by this disclosure. Provided by way of illustration, a suitable polymeric matrix can be an organic polymer, such as polyimide, polyamide, polyaramid, polyurethane, polyurea, polyester, polycarbonate, polysiloxane, polyacrylic, or a blend thereof. In some methods, polyimide is preferred.

Aerogel particles (e.g., 14) can be made in any suitable fashion, such as, for example, by crushing, grinding, or milling aerogel films, aerogel stock shapes, and/or the like. Suitable aerogel particles are also commercially-available. Non-limiting examples of such commercially-available aerogel particles include polyamide aerogel particles (available from BLUESHIFT MATERIALS, INC., Spencer, Massachusetts), SUMTEQ Thermoplastic Aerogel Particles (available from Aerogel Technologies, LLC, Boston, Massachusetts), and Aerogelex Biopolymer Aerogel Particles (available from Aerogel Technologies, LLC, Boston, Massachusetts), with the BLUESHIFT MATERIALS, INC. particles being preferred in some aspects. In some aspects, aerogels can be made by using a process that includes 1) preparation of the polymer gel, 2) optional solvent exchange, and 3) drying of the polymeric solution to form the aerogel. These process steps are described in detail in US 2020/0199323, the disclosure of which is incorporated into the present application by reference. Once the aerogel is made (which can be in the form of a film or stock shape or monolithic block), the aerogel can be crushed, grinded, or milled to form the particles.

The aerogel particles can have any suitable size. For instance, the aerogel particles' sizes can be from 1 μm to 500 μm, or at least, equal to, or between any two of: 1, 5, 10, 20, 30, 40, 50, 60, 70, 80, 90, 100, 150, 200, 250, 300, 350, 400, 450, and 500 μm. And the aerogel particles' particle size distribution can be single-modal or multi-modal (e.g., bimodal, trimodal, etc.). In some methods, the particle size distribution can be bimodal. For example one mode can be from 10 μm to 100 μm, and the other mode can be from 150 μm to 300 μm. In other instances, the particle size distribution may have a single mode or may be trimodal or more. The size of the particles can be obtained by a person having ordinary skill in the art (e.g., by using the crushing, grinding, or milling steps, and an appropriate sieve or filter to obtain a desired particle size).

In some aspects, the aerogel particles and/or resulting articles can have macropores (pores having a size of greater than 50 nanometers (nm) in diameter). In some aspects, the aerogel particles and/or resulting articles can have mesopores (pores having a size of 2 nm up to 50 nm). In some aspects, the aerogel particles and/or resulting articles can have micropores (pores having a size of less than 2 nm). In some aspects, the aerogel particles and/or resulting articles can have macropores and mesopores. In some aspects, the aerogels particles and/or resulting articles can have macropores and micropores. In some aspects, the aerogel particles and/or resulting articles can have mesopores and micropores. In some aspects, the aerogel particles and/or resulting articles can have macropores, mesopores, and micropores. In some aspects, the aerogel particles and/or resulting articles can have a bimodal pore distribution, with one mode being greater than 65 nm and the other mode being less than 65 nm. In some aspects, the aerogel particles and/or resulting articles can have a bimodal pore size distribution, with one mode being greater than 800 nm and the other mode being less than 5 μm. In some aspects, the aerogel particles and/or resulting articles can have a bimodal pore size distribution, with one mode being greater than 600 nm and the other mode being less than 10 μm.

The composition (e.g., 10) can also include an additive to promote consolidation of the aerogel particles. One non-limiting example of such an additive is a plasticizing solvent. Suitable plasticizing solvents include polar aprotic solvents, such as DMSO, DMAc, DMF, HMPA, and/or NMP, or polar protic solvents, such as cresol, phenol, t-butyl alcohol, and/or an alcohol-containing terpene (e.g., citronellol, terpinol). In some methods, DMSO is preferred. Other exemplary plasticizing solvents include ketone-based solvents (e.g., 2-pentatone, 3-pentatone), ketone-containing terpenoids (e.g., camphor), aldehydes (e.g., butanal), aldehyde-containing terpenals (e.g., citral), terpenes (e.g., limonene), and/or the like. Such a plasticizing solvent can, by at least partially plasticizing the aerogel particles, promote bonding of the particles, in some instances, via their polymeric matrices. In at least this way, lower temperatures and/or pressures can be used to consolidate the aerogel particles, the need for a binder can be reduced or eliminated, and/or the like.

If used, the plasticizing solvent can be, for example, from 0.5% to 5% or from 2% to 5% of the weight of the aerogel particles and the plasticizing solvent. Such a plasticizing solvent can be added to the aerogel particles before they are disposed in the mold and/or after they are disposed in the mold. In some instances, the plasticizing solvent may be present in the aerogel particles as a result of the process used to make the particles' aerogel.

As an additional or alternative consolidation-promoting additive, a binder can be used. One non-limiting example of such a binder is epoxy. In some methods, the binder is included in an amount that promotes effective consolidation of the aerogel particles without undesirably hindering the particles' aerogel properties. For instance, the binder can be from 1% to 30%, 2% to 20%, 1% to 10%, 3% to 7%, 4% to 6%, or approximately 5% of the weight of the aerogel particles and the binder. Such a binder can also increase the structural properties of the resulting aerogel article (e.g., 34, discussed below). For example, using a binder can result in an aerogel article that has an ultimate compressive strength of at least 1 MPa, optionally, at least 2 MPa and/or an aerogel article that has a modulus of elasticity that is greater than or equal to any one of, or between any two of: 10, 12, 14, 16, 18, 20, 22, 24, 26, 28, 30, 32, 34, 36, 38, and 40 MPa.

Once the composition is disposed in the mold, an aerogel article (e.g., 34, FIG. 1C) can be formed at least by applying pressure to the composition. For example, as shown in FIG. 1B, mold portion 22a can be moved relative to mold portion 22b to compress the composition between the mold portions. In some methods, facilitated by one or more consolidation-promoting additives, the aerogel particles may not be exposed a pressure that exceeds 5, 10, 25, 50, 75, 100, 125, 150, 175, 200, 225, or 250 psi (e.g., 10 psi). In this way, crushing of the aerogel particles can be mitigated, which might otherwise negatively impact their aerogel properties.

In addition to pressure, in some methods, heat can be applied to the composition disposed in the mold to facilitate formation of the aerogel article. The heat can be provided by, for example, heated mold portions, light, microwaves, and/or the like. In some such methods, the heat is applied such that, for each of at least a majority of—up to and including substantially all of—the aerogel particles, the aerogel particle is not exposed to a temperature that exceeds the glass transition temperature or the melting temperature of the polymeric matrix. In some methods, applying heat is performed such that the aerogel particles are not exposed to a temperature that exceeds 300° C. In one or more of these ways, melting of the aerogel particles can be mitigated, which—like crushing—might otherwise negatively impact their aerogel properties.

As shown in FIG. 1C, the aerogel article can then be removed from the mold. In some methods, one or more secondary curing processes can then be performed, such as, for example, a vacuum bake out process and/or a stepwise thermal cycling process. As shown, the aerogel particles can form at least a majority of the outer surface of the aerogel article. The aerogel article may be relatively thick, such as, for example, having a thickness 38 that is greater than 1.0, 2.0, 3.0, 3.5, 4.0, 4.5, or 5.0 cm. While the aerogel article is depicted as a rectangular block, the present methods can be used to produce aerogel articles of any suitable shape, such as those having curved and/or planar outer surfaces.

The aerogel article can have properties that are comparable to traditional, non-particle-based aerogel articles. For example, the aerogel article can have a density that is less than 0.75 g/cm³, optionally, a density that is from approximately 0.2 g/cm³ to approximately 0.5 g/cm³. For further example, the aerogel article can have a 10% decomposition temperature that is from 350° C. to 650° C. or from 400° C. to 600° C.

Referring now to FIGS. 2A and 2B, using different consolidation-promoting additives can result in different aerogel article structures. To illustrate, in embodiments in which a plasticizing solvent is used, the aerogel particles may bond to one another via their polymeric matrices. And in embodiments in which a binder (e.g., 30) is used, the binder may bond the aerogel particles to one another.

The articles of the present invention can be formed into a wide variety of shapes and/or sizes due to the particle consolidation process of the present invention. The shapes and/or sizes can be controlled by the shape and/or size of any given mold. All shapes and/or sizes are contemplated in the context of the present invention. Non-limiting examples that can incorporate the articles of the present invention include wafers, blankets, core composite materials, insulating materials for residential and commercial windows, insulation material for transportation windows, insulation materials for transparent light transmitting applications, insulation materials for translucent light transmitting applications, insulation materials for translucent lighting applications, insulation materials for window glazings, substrates for radiofrequency antennas, substrates for sunshields, substrates for sunshades, substrates for radomes, insulating materials for oil and/or gas pipelines, insulating materials for liquefied natural gas pipelines, insulating materials for cryogenic fluid transfer pipelines, insulating materials for apparels, insulating materials for aerospace applications, insulating materials for buildings, cars, and other human habitats, insulating materials for automotive applications, insulation for radiators, insulation for ducting and ventilation, insulation for air conditioning, insulation for heating and refrigeration and mobile air conditioning units, insulation for coolers, insulation for packaging, insulation for consumer goods, vibration dampening, wire and cable insulation, insulation for medical devices, support for catalysts, support for drugs, pharmaceuticals, and/or drug delivery systems, aqueous filtration apparatus, oil-based filtration apparatus, and solvent-based filtration apparatus, or any combination thereof.

### EXAMPLES

The present invention will be described in greater detail by way of specific examples. The following examples are offered for illustrative purposes only and are not intended to limit the invention in any manner. Those of skill in the art will readily recognize a variety of noncritical parameters which can be changed or modified to yield essentially the same results.

### A. Example 1—Mixtures Containing Aerogel Particles and a Plasticizing Solvent (DMSO)

Polyimide aerogel particles available from BLUESHIFT MATERIALS, INC., were used. DMSO was used as a plasticizing solvent. Varying amounts of DMSO were weighed and dissolved in acetone to obtain four DMSO solutions with varying DMSO concentrations. Four mixtures of DMSO-aerogel particles were made by adding the DMSO solutions to dry aerogel particles. The mixtures were left under ambient conditions to evaporate the solvent. After solvent evaporation, the final DMSO concentrations in the four mixtures were 2 wt. %, 3 wt. %, 5 wt. %, 10 wt. %, and 30 wt. %, respectively.

### B. Example 2—Mixtures Containing Aerogel Particles and a Binder (Epoxy Resin)

Polyimide aerogel particles available from BLUESHIFT MATERIALS, INC., were used. An epoxy resin, IN2 EPOXY INFUSION RESIN available from EASYCOMPOSITES, was used as a binder. Varying amounts of epoxy resin and hardener were mixed with chloroform. The epoxy in chloroform was added to the aerogel powders in water to obtain 5 epoxy-aerogel particle mixtures. The mixtures were left under ambient conditions to evaporate, at least partially, the solvents. After solvent evaporation, the final epoxy concentrations in the five epoxy-aerogel particle mixtures were 2 wt. %, 3 wt. %, 5 wt. %, 9 wt. %, and 20 wt. % respectively.

### C. Example 3—Stock Shapes Made from the Aerogel Particle Mixtures and their Properties

### 1. Making the Stock Shapes

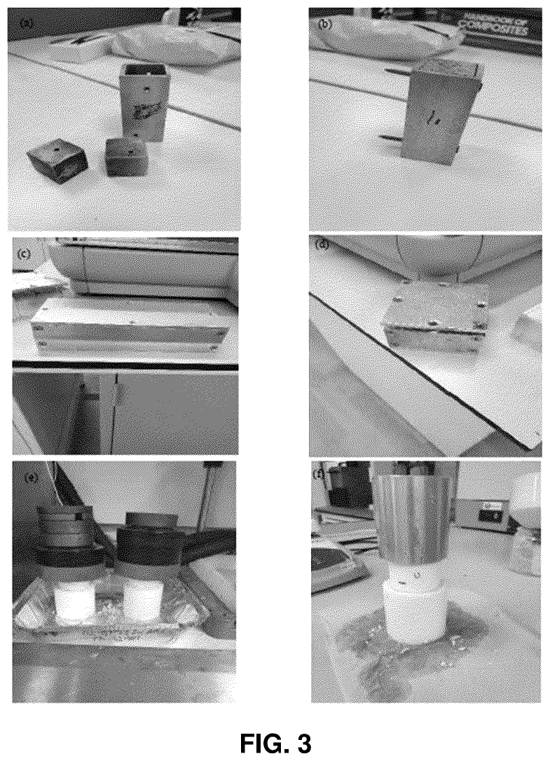

The mixtures from Examples 1 and 2 were poured, separately, into aluminum and polytetrafluoroethylene (PTFE) molds. Molds of various sizes (1×1×1 inch, 8×3×1 inch, and 3×3×1 inch) were used. Aluminum molds were sprayed inside with a silicone release agent to facilitate demolding. PTFE molds were used for their chemical resistance, thermal resistance, non-stick, and low friction properties. FIG. 3 shows various aluminum and PTFE molds used. The DMSO-aerogel particle mixtures and epoxy-aerogel particle mixtures in the molds were cured to obtain stock shapes containing the respective mixtures. The epoxy-aerogel particle mixtures were cured for 24 hours in ambient conditions and then 6 hours at 80° C.

### 2. Properties: Measurement Methods

Thermal stability, surface area, compression strength, and modulus of elasticity of the stock shapes were measured and compared with commercially available polyimide stock shapes available from BLUESHIFT MATERIALS, INC.

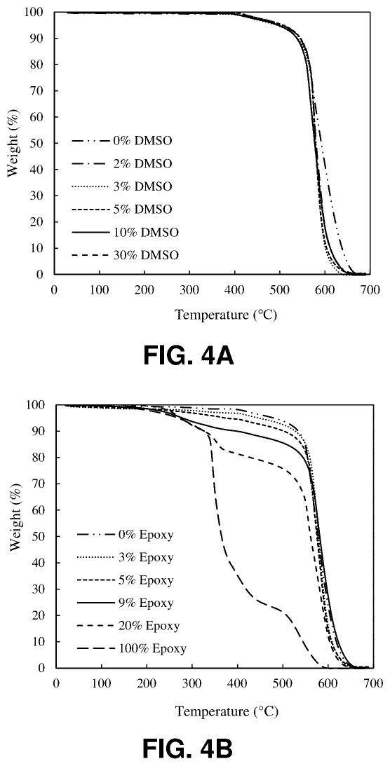

Thermal stabilities of the stock shapes were measured by thermogravimetric analysis using a TA Instruments Q50 thermogravimetric analyzer (TGA). For each experiment, the temperature was changed from 0° C. to 700° C. with a ramp rate of 10° C./min. The difference in weight of the sample against the temperature was plotted (FIGS. 4A and 4B) to obtain the TGA 10% weight loss temperature for the samples, the temperature below which less than 10% of the sample is lost. Samples with high thermal stability generally have a high TGA 10% weight loss temperature.

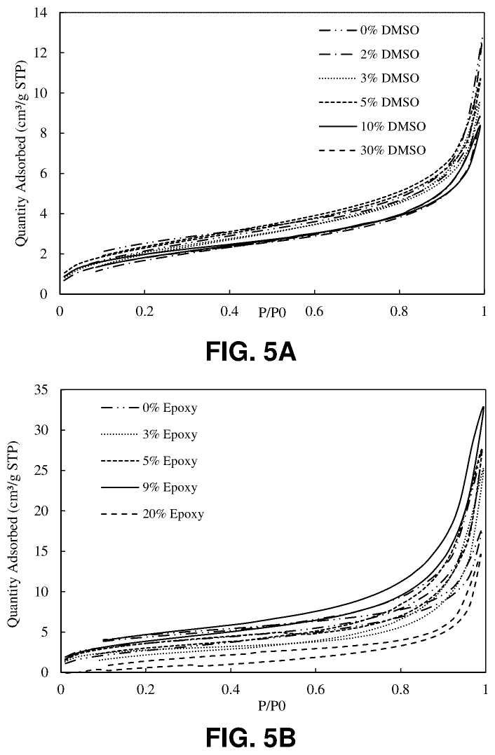

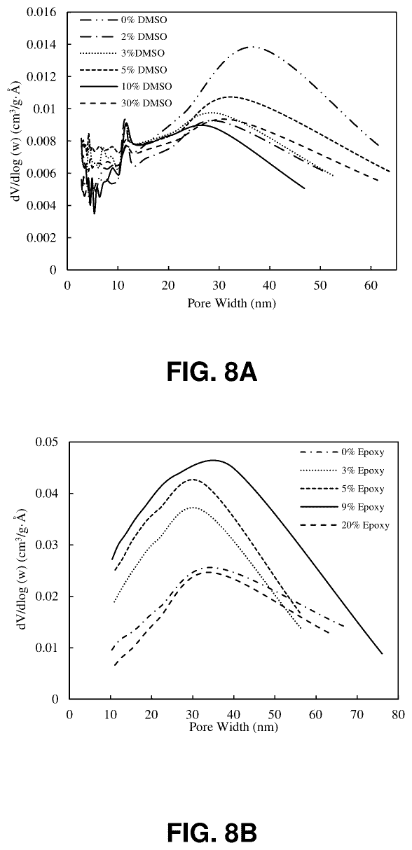

The surface area, pore size distribution, and total pore volume of the stock shapes was measured by Brunauer-Emmett-Teller (BET) method using nitrogen adsorption on a Micromeritics ASAP2420 Surface Area and Porosity Analyzer. Approximately 0.2 g of sample was subject to a degas cycle of 30 min at 50° C., followed by 120 min at 120° C., at a pressure of 10 mmHg. This process removed any residual solvent or surface contaminants from the samples. Degassed samples subsequently underwent a 40 point adsorption cycle between the relative pressures of 0.01 and 1, followed by a 30 point desorption cycle between the relative pressures of 1 and 0.1. Sample temperature was maintained at a constant value of −196° C. throughout the experiment by use of a liquid nitrogen bath. Adsorption-desorption isotherms for the samples are shown in FIGS. 5A and 5B. The pore size distribution curves using BJH method are shown in FIGS. 8A and 8B.

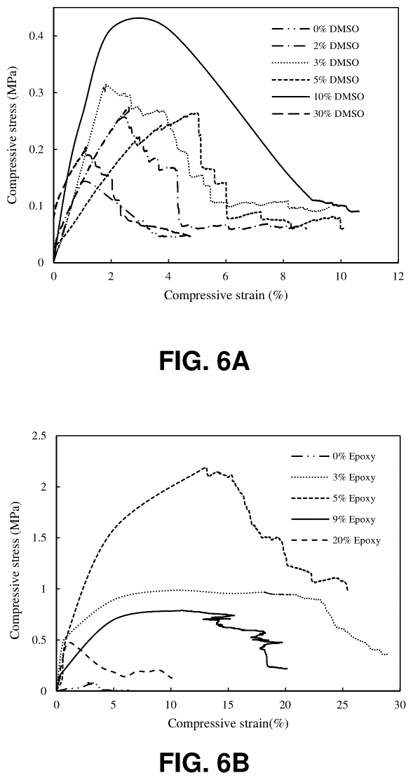

The compression strength and modulus of elasticity of the samples were measured using a compression test machine (Instron 50KN Mechanical Tester). For each experiment, the instrument cross head was moved at 0.65 mm/min. Stress-strain curves for the samples are shown in FIGS. 6A and 6B. For stock shapes containing 3 wt. %, 5 wt. %, 9 wt. %, and 20 wt. % epoxy binder, the experiments were run in triplicates.

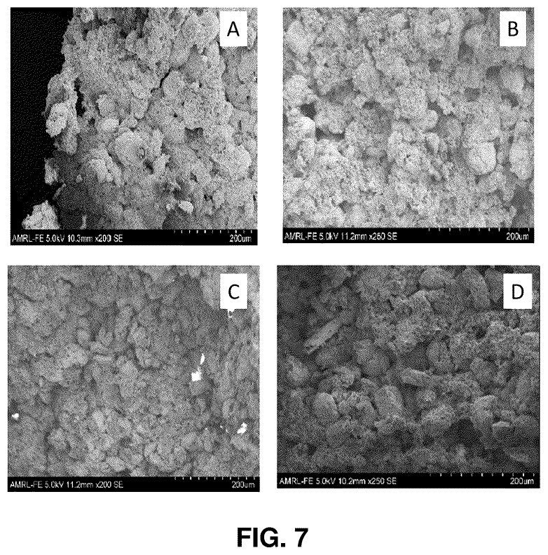

Field Emission Scanning Electron Microscopy (FE-SEM) was used for observing the molecular and surface structure of stock shapes made using epoxy binder. A 5 kV accelerating voltage was used. The samples were gold coated as they were not conductive. The SEM image for the stock shapes containing epoxy-aerogel particles are shown in FIG. 7.

The thermal conductivity of the stock shapes was measured using transient hot-wire method on a XIATECH TC3000E according to ASTM C1113-2019. The hot wire sensor was placed between two samples. The minimum thickness and the length for each sample should be more than 0.3 mm and 3 cm respectively. A Pyrex glass was put on the samples on top of the sensor to ensure a uniformly distributed load applied. A cylindrical weight (500 g) was then put on the Pyrex glass to ensure the sensor was well contacted with both sample surfaces. Before testing, the device was calibrated by a standard PMMA glass.

The % porosity and pore size distribution of the stock shapes was obtained by mercury intrusion porosimetry (MIP) on a Quantachrome Poremaster. Approximately 0.2 g of sample was weighed into a penetrometer and sealed. The penetrometer was subjected to low pressure analysis, where after pulling a vacuum of 10 mTorr, the penetrometer is filled with mercury. The volume of mercury intruded/extruded up to 50 psi was then measured. The mass of the filled penetrometer was then recorded to allow for density calculations. After adding the high pressure jacket, the high pressure stage measured the volume of mercury intruded/extruded up to 40,000 psi.

### 3. Properties: Results

The thermal stability, surface area, compression strength, and modulus of elasticity of the stock shapes prepared with mixtures from Examples 1 and 2 are listed in Tables 1 and 2, respectively.

Table 1 shows stock shapes containing aerogel particles with plasticizing solvent having densities below 0.30 g/cm³. The stock shapes show high porosities which range between 81.7% to 88.8%. In stock shapes made with plasticizing solvent, as DMSO level increases the thermal conductivity also increases from 48 mW/m·K for 3% DMSO to 53 mW/m·K for 30% DMSO which is 4% to 15% increase compared to stock shapes with no plasticizer solvent.

Table 2 shows stock shapes containing aerogel particles with epoxy resin show higher compression strength and modulus of elasticity compared to stock shapes made with plasticizer. The compressive strength of the stock shapes made with plasticizer could not be measured as the sample disintegrated before the 10% compressive strain was applied. Particularly, stock shapes containing aerogel particles with 5 wt. % epoxy provides better compression strength and modulus of elasticity compared to samples prepared with 3%, 9%, and 20% epoxy (Table 2) Stock shapes containing aerogel particles with 5 wt. % epoxy also showed higher compression strength and modulus of elasticity than stock shapes made by Blueshift Materials. Table 2 shows stock shapes containing aerogel particles with epoxy resin have densities between 0.28 g/cm³ to 0.39 g/cm³ and porosities between 71.0% and 84.8%.

TABLE 1
Properties of stock shapes containing DMSO-aerogel particles.

| | | | | | | TGA | |
|---|---|---|---|---|---|---|---|
| | | | | Total | Modulus | (Temp | |
| Stock | MIP | Bulk | Surface | Pore | of | at 10% | Thermal |
| Shape | Porosity | Density | Area | Volume | Elasticity | wt. loss) | Conductivity |
| Sample | (%) | (g/cm³) | (m²/g) | (cm³/g) | (MPa) | (° C.) | (mW/m · K) |
| 0% DMSO | 78.8 | 0.27 | 7.7 | 0.016 | 15.6 | 545 | 46 |
| 3% DMSO | 83.9 | 0.28 | 8.0 | 0.015 | 17.8 | 535 | 48 |
| 5% DMSO | 81.7 | 0.25 | 8.5 | 0.017 | 6.9 | 545 | 50 |
| 10% | 82.6 | 0.24 | 8.1 | 0.020 | 30.7 | 535 | 51 |
| DMSO | | | | | | | |
| 30% | 88.8 | 0.22 | 8.4 | 0.016 | 10.7 | 535 | 53 |
| DMSO | | | | | | | |

TABLE 2
Properties of stock shapes containing Epoxy-aerogel particles.

| | | | | | | | TGA |
|---|---|---|---|---|---|---|---|
| | | | | Total | Compressive | Modulus | (Temp at |
| | MIP | Bulk | Surface | Pore | Strength, | of | 10% wt |
| Stock Shape | Porosity | Density | Area | Volume | 10% strain | Elasticity | Loss) |
| Samples | (%) | (g/cm³) | (m²/g) | (cm³/g) | (MPa) | (MPa) | (° C.) |
| 0% Epoxy | 66.5 | 0.28 | 8.9 | 0.03 | — | 2.2 | 530 |
| 3% Epoxy | 73.6 | 0.34 | 9.5 | 0.04 | 0.99 | 84.9 | 520 |
| 5% Epoxy | 71.0 | 0.36 | 13.1 | 0.04 | 2.19 | 90.6 | 500 |
| 9% Epoxy | 81.1 | 0.38 | 14.3 | 0.05 | 0.78 | 36.4 | 390 |
| 20% Epoxy | 84.8 | 0.39 | 7.9 | 0.02 | 0.13 | 58.1 | 320 |
| AEROZERO | — | 0.20 | — | — | 1.8 | 21 | 550 |
| Stock Shape | | | | | | | |

For stock shapes made with epoxy binder, as the epoxy level increases the thermal conductivity also increases from 49 mW/m·K to 59 mW/m·K in comparison to stock shapes with no binder. In general, stock shapes made with DMSO as plasticizer show slightly lower thermal conductivities than stock shapes with epoxy binder. In general, TGA 10% weight loss temperatures of stock shapes made with DMSO as plasticizer are higher than stock shapes with epoxy binder. In general, stock shapes made with epoxy binder are stronger, according to the modulus, than stock shapes made with DMSO as plasticizer. The AEROZERO Stock Shape (commercially available from Blueshift Materials, Inc. (Spencer, Massachusetts) was a comparative aerogel article made by the solvent-exchange and drying process of a formed gel described in the Description of Related Art to produce the AEROZERO Stock Shape. No epoxy resin and no consolidation of aerogel particles were used to make the AEROZERO stock shape. The dimensions of the AEROZERO Stock Shape used for this experiment were 1 inch×1 inch×1 inch.

FIG. 8 shows the pore size distributions obtained using BJH method on nitrogen desorption data on the aerogel articles made using DMSO as plasticizer (FIG. 8A) and using epoxy (FIG. 8B). Using the BJH method, pore sizes are between 10 and 50 nm, indicating that the stock shapes consist of mesoporous aerogels.

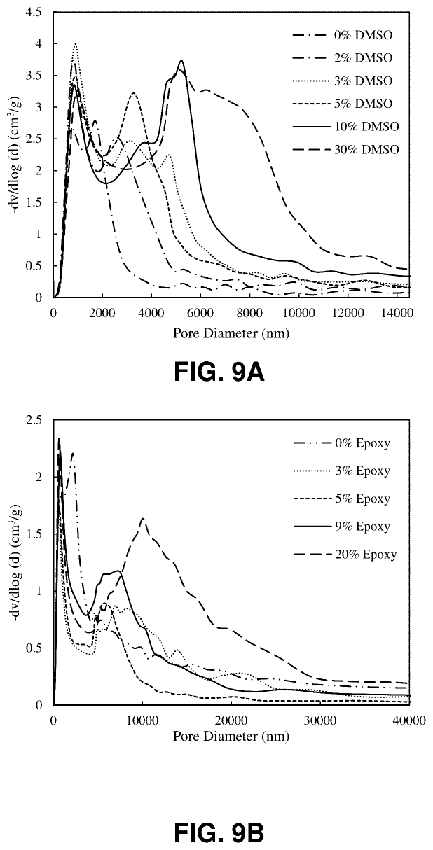

FIG. 9 shows the pore size distributions obtained using mercury intrusion porosimetry on the aerogel articles made using DMSO as plasticizer (FIG. 9A) and using epoxy (FIG. 9B). Aerogel particles show bimodal pore size distribution. The pore sizes of aerogel particles made with DMSO measured using mercury intrusion porosimetry are larger than 1 μm and less than 5 μm. Aerogel particles made with epoxy show particle sizes between 600 nm and 10 μm.

The above specification and examples provide a complete description of the structure and use of illustrative embodiments. Although certain embodiments have been described above with a certain degree of particularity, or with reference to one or more individual embodiments, those of ordinary skill in the art could make numerous alterations to the disclosed embodiments without departing from the scope of this invention. As such, the various illustrative embodiments of the apparatuses and methods are not intended to be limited to the particular forms disclosed. Rather, they include all modifications and alternatives falling within the scope of the claims, and embodiments other than the ones shown may include some or all of the features of the depicted embodiments. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

The claims are not intended to include, and should not be interpreted to include, means plus- or step-plus-function limitations, unless such a limitation is explicitly recited in a given claim using the phrase(s) “means for” or “step for,” respectively.

1. An aerogel article comprising:
a plurality of aerogel particles, each comprising a polymeric matrix defining pores of the plurality of aerogel particles,
wherein the polymeric matrix comprises a non-consolidated portion comprising the pores and a consolidated portion plasticized by a plasticizing solvent, and
wherein the plurality of aerogel particles are bonded to each other through an interface that comprises the consolidated portions of adjacent ones of the plurality of aerogel particles.

2. The aerogel article of claim 1, wherein the aerogel article comprises at least 90 wt. % of the plurality of aerogel particles.

3. The aerogel article of claim 2, wherein the polymeric matrix comprises polyimide.

4. The aerogel article of claim 2, wherein the interface further comprises the plasticizing solvent.

5. The aerogel article of claim 4, wherein the aerogel article comprises 0.01 wt. % to 10 wt. % of the plasticizing solvent.

6. The aerogel article of claim 5, wherein the plasticizing solvent comprises a polar aprotic solvent.

7. The aerogel article of claim 6, wherein the polar aprotic solvent comprises DMSO, DMAc, DMF, HMPA, or NMP, or any combination thereof.

8. The aerogel article of claim 7, wherein the polar aprotic solvent comprises DMSO.

9. The aerogel article of claim 1, wherein the plurality of aerogel particles have a size of 1 μm to 500 μm.

10. The aerogel article of claim 1, wherein the plurality of aerogel particles have a biomodal particle size distribution, wherein a first mode has a particle size distribution of 10 μm to 100 μm, and the second mode has a particle size distribution of 150 μm to 300 μm.

11. The aerogel article of claim 1, wherein the plurality of aerogel particles comprise macropores.

12. The aerogel article of claim 1, wherein the plurality of aerogel particles comprise at least a bimodal pore distribution, with a first mode being greater than 65 nm and a second mode being 65 nm or less.

13. The aerogel article of claim 1, wherein the polymeric matrix comprises an organic polymer.

14. The aerogel article of claim 1, wherein the aerogel article has an ultimate compressive strength of at least 1 MPa, optionally, at least 2 MPa.

15. The aerogel article of claim 1, wherein the aerogel article has a density that is less than 0.75 g/cm³.

16. The aerogel article of claim 15, wherein the aerogel article has a density that is 0.2 g/cm³ to 0.5 g/cm³.

17. The aerogel article of 1, comprising all of the following properties:
(a) a porosity of 70% to 90%;
(b) a bulk density of 0.30 g/cm³ to 0.45 g/cm³;
(c) a surface area of 7.75 m²/g to 15.0 m²/g;
(d) a pore volume of 0.02 cm³/g to 0.06 cm³/g;
(e) a modulus of elasticity of 35 MPa to 95 MPa;
(f) a TGA 10% weight loss temperature of 315° C. to 525° C.; and
(g) a thermal conductivity of 47 mW/m K to 60 mW/m K.

18. The aerogel article of claim 1, wherein the aerogel article has a thickness of at least 1 cm.

19. The aerogel article of claim 1, wherein the plurality of aerogel particles form at least a majority of the outer surface of the aerogel article.

20. The aerogel article of claim 1, wherein the aerogel article is in the form of a film.

21. The aerogel article of claim 1, wherein the aerogel is in the form of a stock shape or monolithic block.
